(19) United States
(12) Patent Application Publication
(10) Pub. No.: US 2005/0230340 A1
(43) Pub. Date: Oct. 20, 2005

(54) Portable crane/winch/hoist

(76) Inventors: James A. Barger SR., Slidell, LA (US); Paul J. Hubbell JR., Metairie, LA (US)

Correspondence Address: Paul J. Hubbell, JR., P. O . Box 541, Metairie, LA, 70004, US

(21) Appl. No.: 10/657,029

(22) Filed: Apr. 20, 2004

(51) Int. Cl. B66C 13/30

(52) U.S. Cl. 212/280

(57) ABSTRACT

Two embodiments (FIGS. 1 and 4) of a portable crane/winch/hoist allowing a safe flexible use with attachments to a vehicle or other designated use area while simple to assemble/disassemble with it's relatively light weight sections allows for a one person assembly and operation, is not intrusive to a vehicle's body nor is permanently attached and exposed to the elements. This device allows for a safe operation to load and unload objects while not being risky for a strain or injury when attempted by only one person in lieu of requiring two or more persons to accomplish the task. By reducing the injury risk thus limiting the potential for missed work hours and insurance claims; should result in enhanced performance production and insurance friendly rates. Additionally, this device can be adapted to shop work benches and other areas, as well as multiple vehicles particularly in the service industry i.e.; delivery, electrical, HVAC, plumbing, lawn equipment, recreational vehicles, SUV's, vans, boats/motors. The present invention, being sectional, is relatively easy to manufacture, assemble, operate, disassemble and store. Said device is “user friendly” and economically affordable considering the existing products presently in the industry.

### REFERENCE TO RELATED DISCLOSURES

The present application includes and refers to Disclosure Serial No. 500020 of Aug. 31, 2001 and also amended Disclosure Serial No. 526798 of Feb. 18, 2003. Both Disclosures are titled Portable Crane/Hoist/Winch.

This application includes a notarized copy of an assignment agreement of 50% ownership from James A. Barger Sr. to Paul J. Hubbell, Jr. (co-owners of “U-RIG-IT” LLC).

Additionally, a Certificate of Mailing and a self-addressed Post Card for receipt are included.

### TECHNICAL FIELDS

The present invention initially relates to the cranes used in the service industry to lift loads to and from a vehicle i.e., trucks and are uni-mounted assemblies permanently attached/mounted (not portable) to the vehicle body/bed or vehicle tool box which are exposed to the elements resulting in extra wear and tear and maintenance. Additionally, when lifting, the entire load force bears down on the vehicle.

The “Barger” invention addresses and solves the above problems since it is a portable, lightweight sectional/telescopic device which can be easily assembled/disassembled by only one person, is not permanently attached to a vehicle and exposed to the elements resulting in less maintenance, connects to a trailer hitch and allows the vertical load force to transfer form the vehicle body to the ground terrain via it's supporting adjustable foot/base.

Additionally, this device is labor friendly and offers a safe work-place environment while reducing man hours and producing increased job performance, especially when comparing the loading/unloading job task by one or more persons in a manual mode which can be unhealthy and injury prone.

This device is a very affordable investment when compared to existing products in the industry.

### BACKGROUND/PRIOR ART

Many cranes used in the industry today are uni-mounted assemblies that are permanently attached to a truck bed (FIG. 5) or vehicle tool box (FIG. 5A) and are exposed to the elements resulting in extra maintenance and wear and tear while being restrictive to the loading and unloading area and space available for product storage and transportation. Present system devices do not allow for fast assembly or disassembly since they are constructed in one section that contains the total weight as opposed to the portable light weight sections of the “Barger” invention that are constructed in a fashion that allows one individual to assemble/disassemble, is transferable from one vehicle to multiple others, is not permanently attached to a vehicle's bed (FIG. 5), toolbox (FIG. 5A), or trailer and when lifting, allows the load force to transfer from the vehicle to the ground/terrain.

The prior art contains a number of teachings of cranes, lifts, hoists some of which are portable and disclosed in the following patents: U.S. Pat. No. 6,065,621 issued to Ray Fatemi and Stan Glas (2000), U.S. Pat. No. 378,457 issued to Vernon H. Page (1997), U.S. Pat. No. 424,374 issued to John Boholst (2000), U.S. Pat. No. 6,024,374 issued to Delton Friesen and U.S. Pat. No. 5,738,185 Michael R. Sears (1998).

(U.S. Pat. No. 6,065,621), The Fatemi et al Patent depicts a four wheel vehicle with a permanently mounted crane assembly with a trailer hitch to be connected and towed to various locations by another vehicle. It is portable and constructed with all components sections intact as one and therefore not readily assembled/disassembled. (378,457), The Vernon H. Page Patent Mechanism discloses an “A” frame lift on the horizontal top section supported by two structural legs with flat base feet on one side and two structural legs with wheels on the opposite vertical section, has no motor, is operated by a hand crank and does not attach to a vehicle trailer hitch or function in the same manner as the preferred embodiments of the “Barger” invention. (424,268), the Boholst Device is a hydraulic lift with a limited lift capability as far as vehicles i.e., pick-up trucks or other service vehicles and does not assemble or disassemble readily nor does it attach by means of a trailer hitch to a vehicle and does not extend and rotate 360° to reach objects to be loaded/unloaded. (U.S. Pat. No. 6,024,374), the Freisen Patent depicts a trailer hitch mounted on a hand truck dolly base that attaches to a lightweight trailer and is used only to move same trailer. There is no lifting capabilities and it does not perform any of the functions of the “Barger” rotatable crane. (U.S. Pat. No. 5,738,185), The Sears apparatus is a lifting device connected to a ladder which is more suitable for buildings and does not have a motor and would require a locking device to secure the wheel section and more than one person would be necessary to install, assemble, and operate same. This device does not attach to a vehicle and does not have the capacity to perform the functions of the rotatable sectional “Barger” crane which can be assembled and operated by only one person.

The present “Barger” invention addresses and solves the above mentioned problems when used with the prescribed techniques and provides other advantages over the present means and will be further discussed following.

General Discussion of Invention

### Portable Crane/Winch/Hoist

As noted in the “Prior Art” above, other devices/cranes (FIGS. 5 & 5A) are constructed in an undesirable fashion and pose a safety, health and environmental elements risks resulting in unnecessary maintenance from wear and tear (FIGS. 5 & 5A).

### Methodology

The present invention relates to a portable Crane/Hoist/Winch lifting, loading/unloading device/system that allows for fast, simple connections, operation, disconnections and storage.

Additionally, this aspect of the invention allows for the small number of light weight sections to easily be lifted and assembled by only one person in the work place industry.

Another object of this invention is to provide a time saving labor task since only one individual is required for the total operation.

Accordingly, an object of this “methodology” aspect of the invention is to provide a safer and more secure means of handling, lifting, loading, transferring, unloading and storing a certain category of objects.

An additional object concerns the exposure to the elements of the existing non-portable, permanently attached to truck's bed or tool boxes, which results in more maintenance, wear and tear and less reliability as well as sometimes protruding objects that are unsafe that can cause injuries and damage to areas that are unfavorably restrictive, while in use or in only a transportation mode.

### First Preferred Embodiment

After preparing a trailer hitch (FIG. 1+) on a vehicle for access, the male proximate end of the tubular adapter section is inserted into the female square tubular trailer hitch receptacle and pinned, while the opposite distal female end of the square tubular adapter accommodates a tubular adjustable/telescopic and pinned male proximate end at 90° vertical rise which has a female distal end that receives a male proximate end of a round adjustable vertical rise section for a distance then extends at approximately 30° horizontal rise and contains a motorized or manual winch in the 30° arc, a cable/pulley at the distal end with a lifting hook on the cable/end. This boom section is supported structurally both at the top and bottom.

Once assembly, is in place, the load/base foot support is adjusted to the terrain and after attaching the lifting hook at the end of extended cable from the motorized winch/or hand crank, an object with an eye bolt or harness can be lifted vertically and rotated 360° horizontally with a handle mounted on the vertical rise rotatable section while suspended then lowered onto the desired location of a vehicle such as a truck or other type platform while the reverse operation would be used to unload an object.

The motorized winch has a reversing switch in the power supply cord for this operation and the hand crank is manual.

### Second Embodiment

After preparing the trailer hitch (FIG. 4+) of a vehicle for access, the male proximate end of the tubular adapter section is inserted into the female square tubular trailer hitch receptacle and pinned, while the opposite distal female end of the square tubular adapter accommodates a tubular adjustable/telescopic and pinned male proximate end of a transition from horizontal tubular to round pipe at 90° vertical rise which has a female distal end that receives a male proximate end of an adjustable vertical rise first section for a distance, then extends at approximately 45° horizontally with a female distal end that accepts a second section with a male proximate end extends for another distance with a 45° horizontal rise and contains a motorized or manual winch in the arc of the distal boom section that rises approximately 30° horizontally and has a cable/pulley at the distal end with a lifting hook at the end of the extended cable end and is supported structurally, top and bottom.

Once assembly is in place, the load/base foot support is adjusted to the terrain and after attaching the lifting hook at the end of the extended cable from the motorized winch/hand crank an object with an eye bolt or harness can be lifted vertically and rotated up to 360° horizontally with a handle mounted on the vertical rise section while suspended then lowered onto the desired location of a vehicle such as a truck or other type platform while the operation would be used to unload an object.

The motorized winch has a reversing switch in the power supply cord for this operation, while the hand crank is manual.

### MODES FOR CARRYING OUT THE INVENTION

### Structural Details of 1^{st} Embodiment (FIG. 1A+)

After the vehicle selected to be used is properly parked near the object/load to be moved, the vehicle engine turned off, and the parking brake engaged, assembly may safely begin.

Referring to the four (4) major components shown in FIG. 1A the Portable Crane/Winch/Hoist can be safely and rapidly assembled by only one person following four easy steps:

Step No. 1—Start by inserting the proximate end of the horizontal 90° portable mounting hitch 2, into the distal end of the vehicle tubular square female receptacle 1, locking in place with pin 1a.

Step No. 2—Prepare the tubular square to round pipe 90° angular transition member 3, by threading/turning the load bearing base/foot support lock nut 4c, until the nut bottoms out on the foot 4b, the foot 4b and locknut 4a is then threaded into the distal end of the transition section 3.

Step No. 3—The square tubular proximate end of the 90° transition member 3, is now inserted into the female distal end of the square portable mounting hitch adapter 2, transition member 3 is then locked with pin 2a. This prepares and provides for a rigid safe, stable load bearing platform for the rotatable Crane/Winch section of the assembly 4.

Step No. 4—The round male proximate end of the winch assembly 4 is now inserted into the round female distal end of transition member 3, the base foot 4b is adjusted to the terrain/ground and lock/nut 4a tightened. The pin 3a, is only used as an internal support height adjustment base and as a roller bearing effect for the male distal end of rotatable member 4.

### MODES FOR CARRYING OUT THE INVENTION

### Structural Details of 2^{nd} Embodiment (FIG. 4A+)

After the vehicle selected to be used is properly parked near the object/load to be moved, the vehicle engine turned off, and the parking brake engaged, assembly may safely begin.

Referring to the four (4) major components shown in FIG. 4A the Portable Crane/Winch/Hoist can be safely and rapidly assembled by only one person following four easy steps:

Step No. 1—Start by inserting the proximate end of the horizontal 90° portable mounting hitch 2, into the distal end of the vehicle tubular square female receptacle 1, locking in place with pin 1a.

Step No. 2—Prepare the tubular square to round pipe 90° angular transition member 3, by threading/turning the load bearing base/foot support lock nut 4c, until the nut bottoms out on the foot 4b, the foot 4b and locknut 4c is then threaded into the distal end of the transition section 3.

Step No. 3—The square tubular proximate end of the 90° transition member 3, is now inserted into the female distal end of the square portable mounting hitch adapter 2, transition member 3 is then locked with pin 2a. This prepares and provides for a rigid safe, stable load bearing platform for the rotatable Crane/Winch section of the assembly FIG. 4.

Step No. 4—The round male proximate end of the female distal end that receives the male proximate end of adjustable vertical rise first section 8, w/handle for a distance, then extends at approximately 45° horizontally with a female distal end that (Step 5) connects to a second section 9 w/handle 9a with a male proximate end and extends for another distance with a 45° horizontal rise and contains a motorized or manual winch 6, in the arc of the distal boom section that rises approximately 30° horizontally and has a cable 6a, pulley 6b, at the distal end with a lifting hook 6c at the end of the extended cable end and is supported structurally, top 10 & bottom 10b.

Once assembly is in place, the load/base foot support 4b is adjusted and locked to the terrain and after attaching the lifting hook at the end of the extended cable 6a from the motorized winch/hand crank 6 and object with an eye bold or harness can be lifted vertically and rotated up to 360° horizontally with a handle 9a mounted on the vertical rise section while suspended then lowered onto the desired location of a vehicle such as a truck or other type platform while the reverse operation would be used to unload an object.

The motorized winch has a reversing switch 7b in the power supply cord 7 for this operation, while the hand crank is manual.

This completes the mechanical section of the 1^{st} and 2^{nd} embodiment assemblies.

### Electrical (FIG. 1A & 4+)

The electrical power for the assembled Crane/Hoist is provided by simply connecting the male plug 7a, of cable 7 into the vehicles female power receptacle. If a receptacle is not available, a separate power kit (containing female receptacle power cord with switch and battery connectors).

Other power kits can be used if the winch motor is 120 volts or 208/230 volts single phase.

### Winching Operation

Following the same steps of assembly and mounting as the 1^{st} embodiment FIG. 1A (Steps 1-4), but eliminating section 2, 90° angular tubular component and connecting male proximate end of tubular horizontal section 3p, into female receptacle 1, and pinning 1a, Section 4 male proximate round end is inserted into female round distal end of vertical rise section 3p, and pinned 3a, to form a non-rotatable perpendicular rigid position for a winching operation.

This desired type operation is used when a close distance to the load/object is impossible to reach due to a restrictive area limiting the vehicle to a reasonable remote distance.

The operational mode is to energize switch 7b, to release cable 6a, with lifting hook 6c for a distance to the remote location of the load/object, then attaching the lifting hook 6c, to object and energizing winch motor 6, with switch 7b, to pull object close enough to vehicle and then proceeding with regular lifting, loading/unloading steps of 1^{st} embodiment FIG. 1A.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1A is a sectional/exploded isometric view of a first, currently preferred, exemplary embodiment of the present invention, showing a tubular female trailer hitch receiver 1, a pin 1a, a 90° horizontal angular tubular adapter section 2, a pin 2a, a telescopic square tubular transition to round pipe welded angular vertical rise section 3, a pin 3a, an adjustable load support base/foot 4b, a lock nut 4c, an adjustable/telescopic rotatable vertical pipe boom section with an app'x. 30° horizontal rise 4, a handle 4a, an adjustable telescopic boom extension 5, a pin 5a, a welded base for a bolted winch motor or hand crank 6, a cable 6a, a

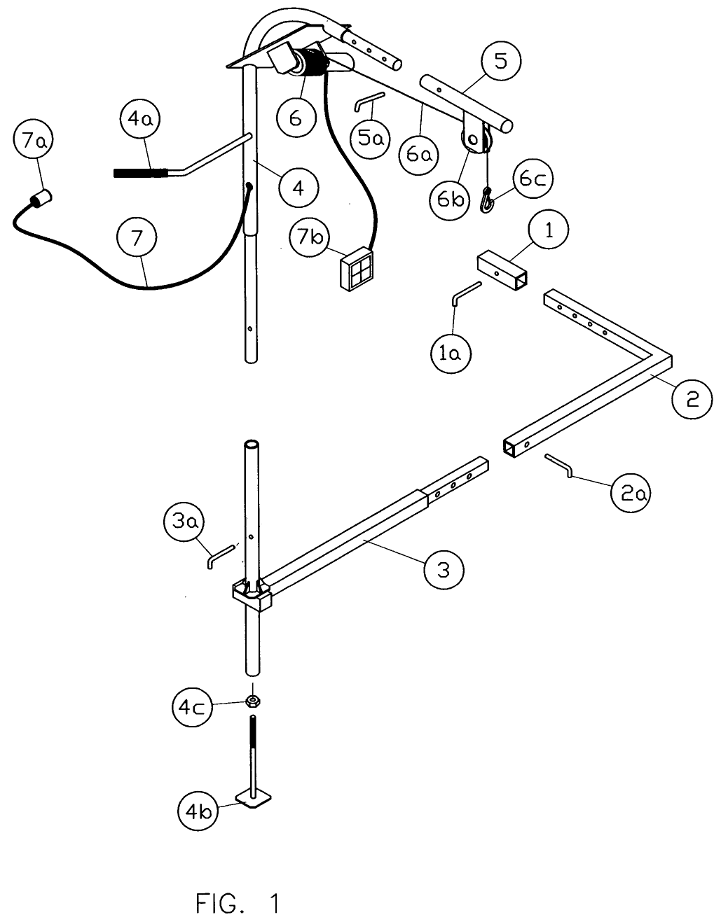

FIG. 1 is an assembled isometric view of the first preferred embodiment mounted to a truck trailer hitch facing outwardly from the rear with tailgate up/closed.

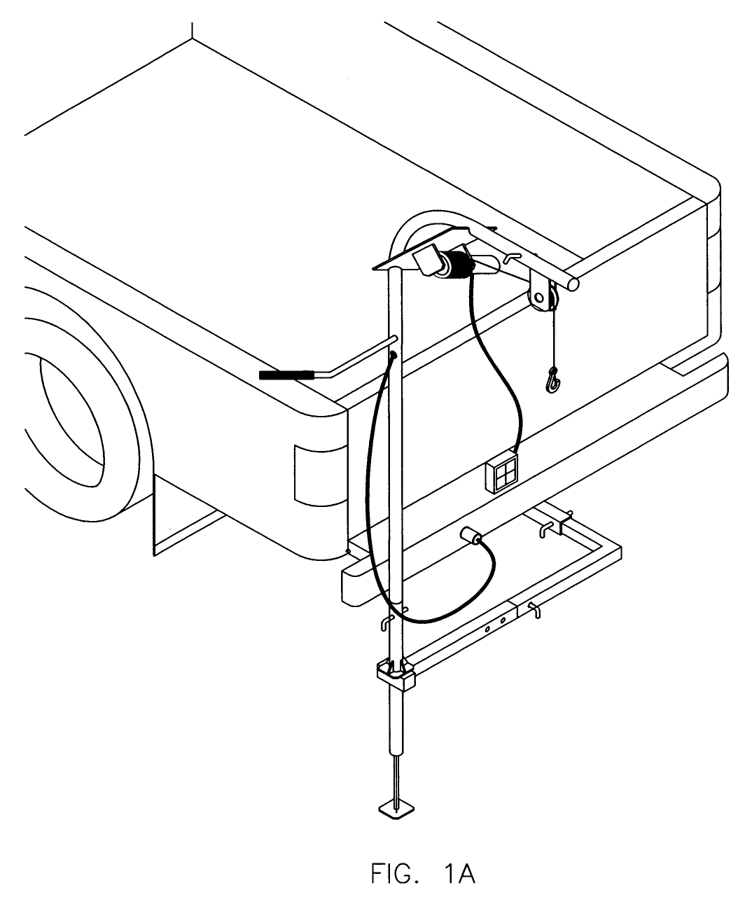

FIG. 2 facing outwardly with tailgate down/open.

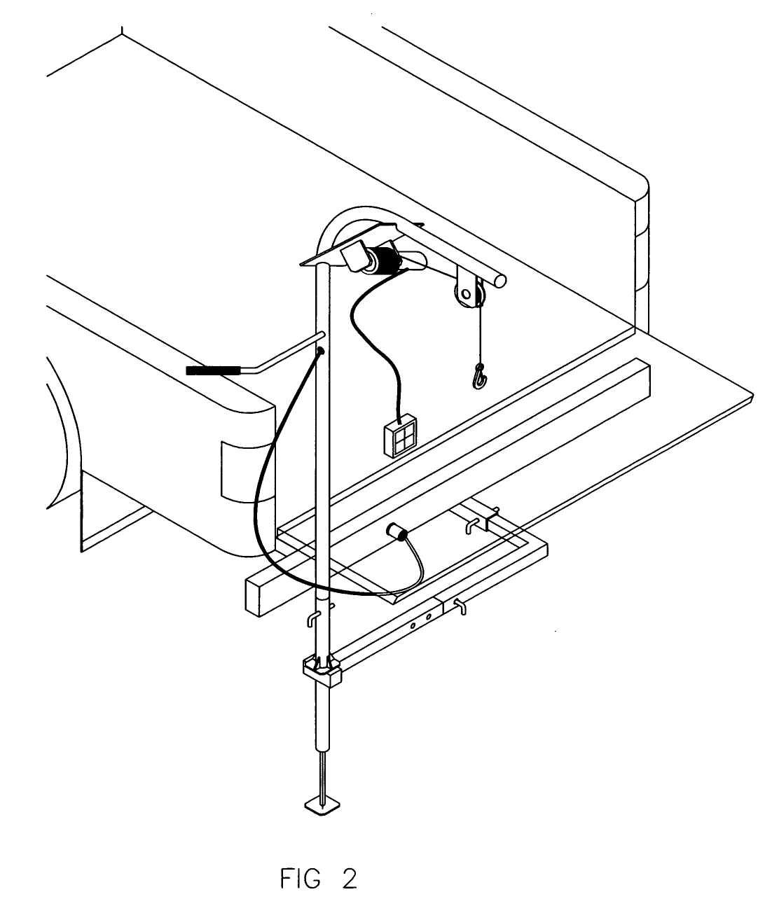

FIG. 2A facing inwardly with tailgate down/open.

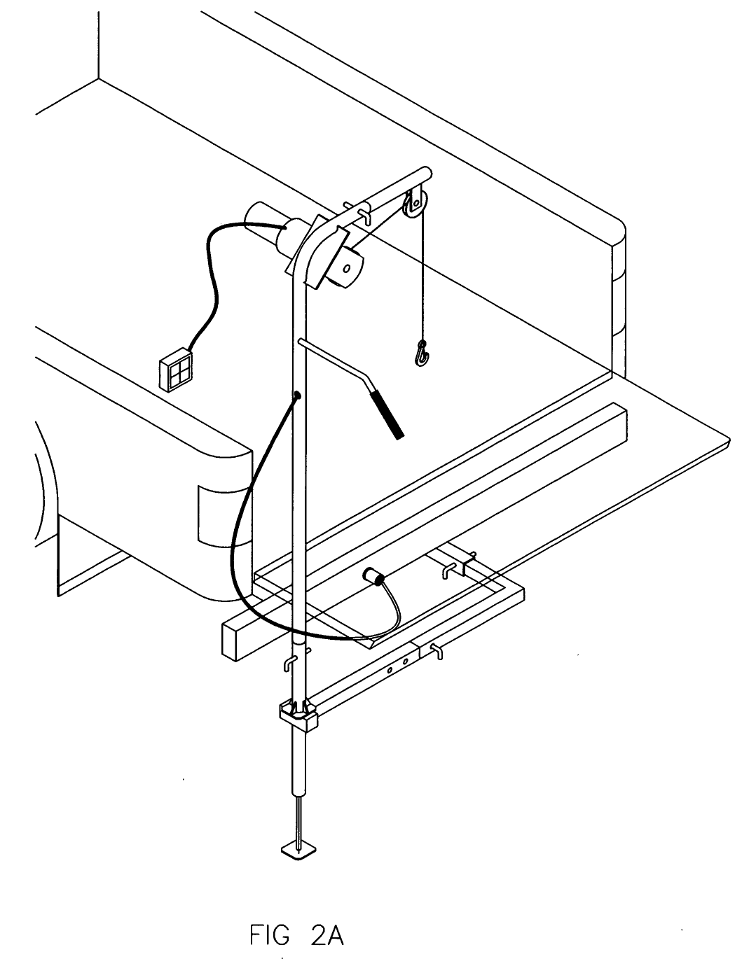

FIG. 3 is a tubular to round transition adapter (3p) mounted to the female trailer hitch 1, a pin 1a, perpendicular to the bumper of the vehicle with a vertical rise of 90°.

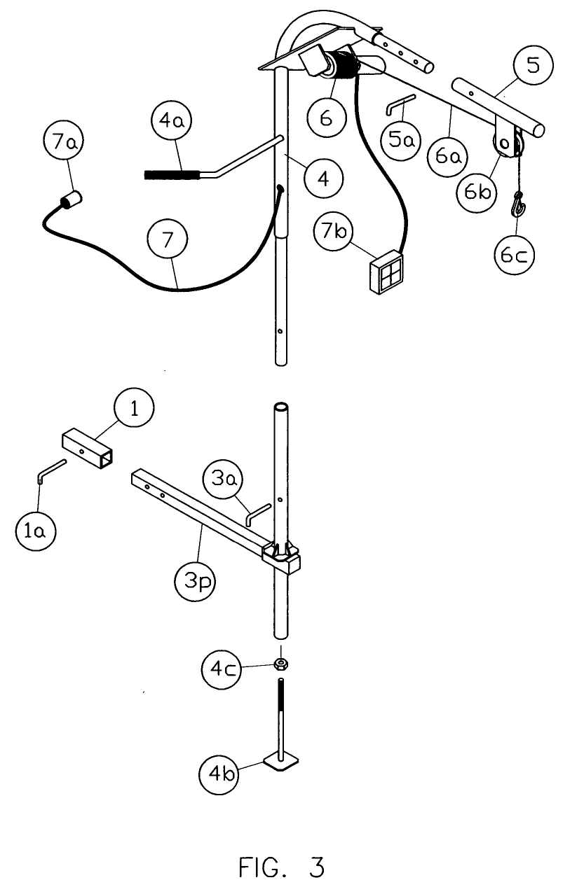

FIG. 4 is an alternate preferred embodiment exploded isometric view depicting a first pipe rotatable section with a 45° vertical to horizontal rise for a distance 8, a handle 8a, connecting to the receiving end of 3, on the proximate end with the distal female end coupling with the proximate end of a second boom section that rises from vertical 30° horizontally 9, a handle 9a, a winch motor welded base for bolted support of motor/hand crank 6, a cable 6a, a pulley 6b, a lifting hook 6c, on the distal end, and each of these two sections 8, & 9, are 360° rotatable forming an extended 90° long sweeping offset.

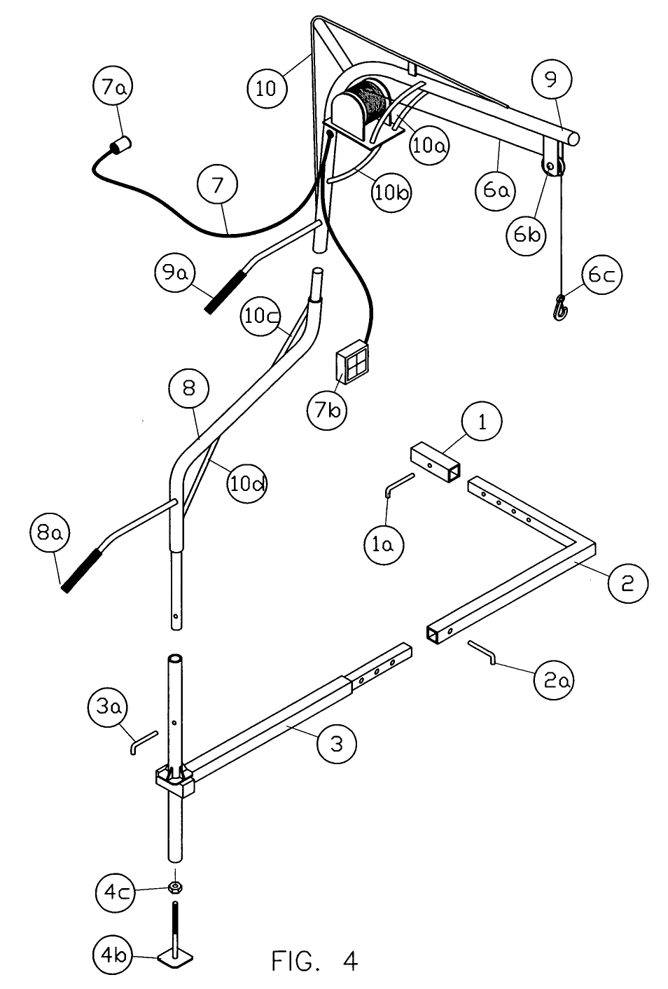

FIG. 4A is an isometric exploded view of the alternate preferred embodiment facing outwardly.

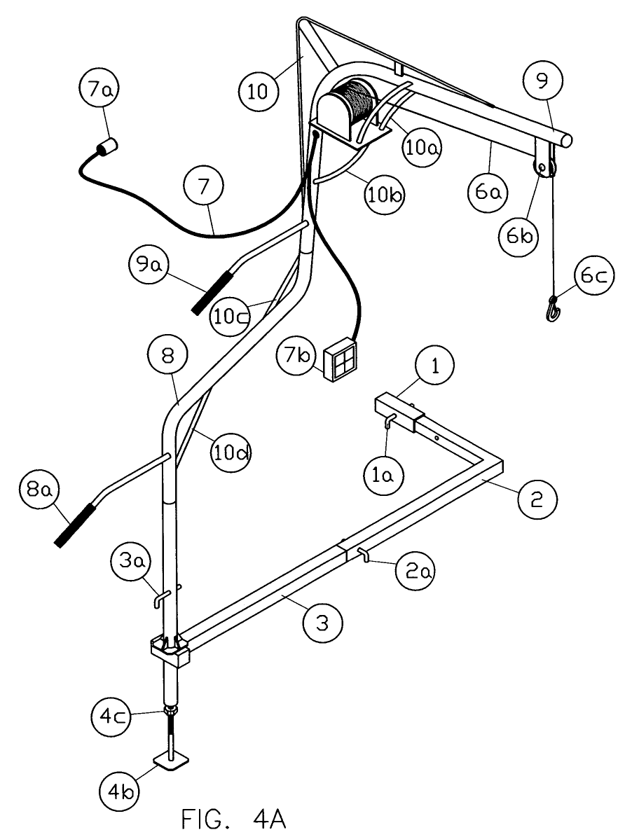

FIG. 4B shows section 3p perpendicular to bumper and pinned.

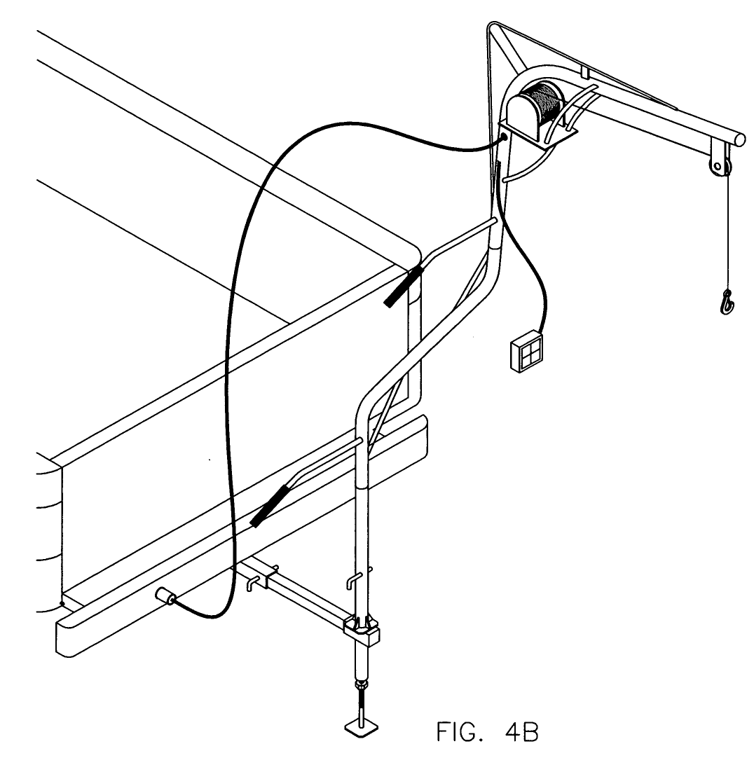

FIG. 4C is an exploded isometric view of FIG. 4B.

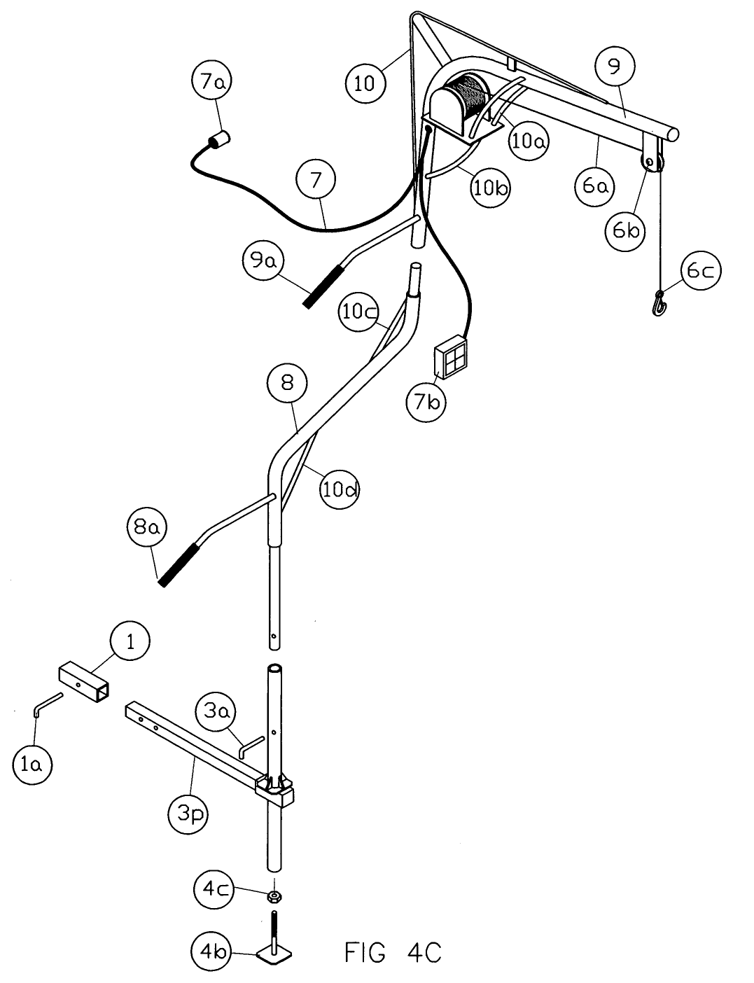

FIG. 5 depicts a perspective view of present/prior non-portable crane permanently attached to a truck body/bed.

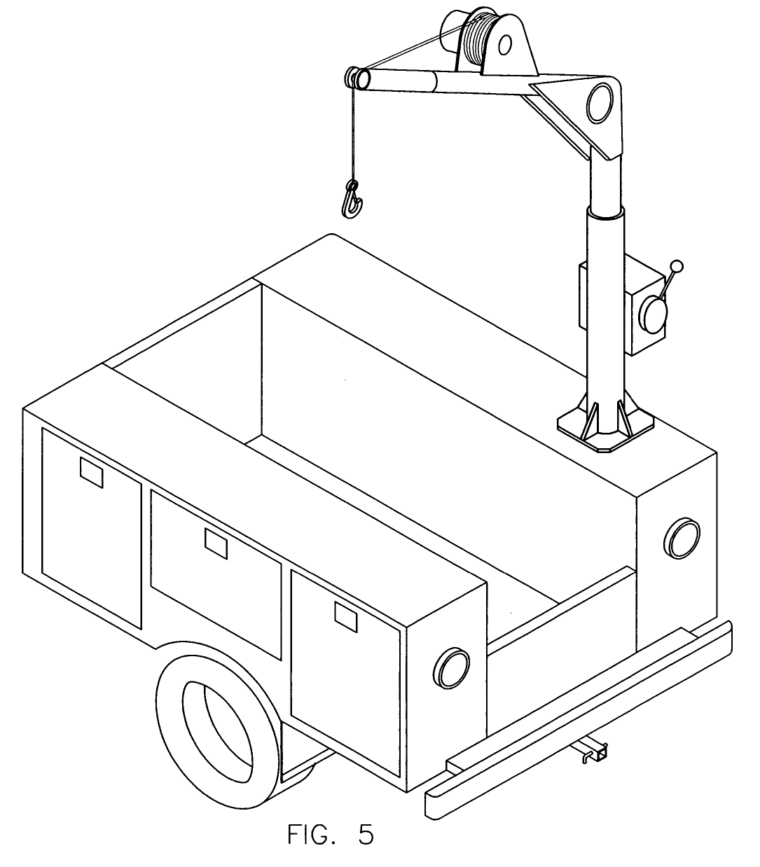

FIG. 5A a uni-mounted non-portable crane permanently mounted to a truck tool box.

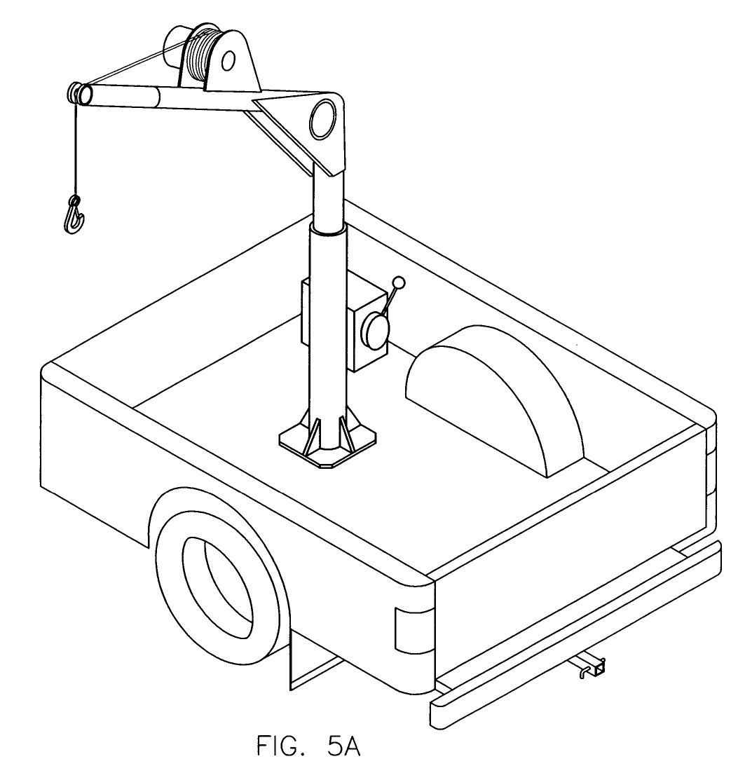

1. A portable crane/winch/hoist device with longitudinal tubular adjustable sections connected in a horizontal plane on one end transitioning to round pipe at 90° vertical rise for a distance then ending with a rotatable boom section that rises 30° horizontally, comprising:
a tubular horizontal male section that inserts into a female receptacle in a trailer hitch and proceeds 90° outwardly and parallel to a vehicle bumper and connects to a transitional section;
an intermediate transition section from horizontal tubular to round rising vertically at 90° with an adjustable load bearing support on the bottom of the transition angle;
a vertical round adjustable 360° rotatable section that inserts into the vertical rise round section of the transition for a distance ascending at approximately 30° horizontally;
a vertical round section rising 30°horizontally, the boom end, containing a winch/motor, cable, pulley, lifting hook, power cable and switch.

2. The assembly of a portable crane/winch/hoist of claim 1, wherein:
a pinned adapter section to the host trailer hitch of a vehicle and a second transition section pinned to the first adapter section for stability.

3. The portable crane/winch/hoist device of claim 1, wherein:
the transition vertical rise member contains an adjustable load bearing, adjustable foot/base for adaptation to the terrain/ground with lock nut to secure same.

4. The assembly of claim 1, includes a 90° transition rise member with a pin bore through the round internal passageway located approximately 8-10 inches above the bottom of the pipe and serves as an adjustable height/roller bearing effect when employed, which aids in the rotation of the boom section.

5. A boom section that includes a handle to rotate the load horizontally while suspended.

6. A boom section of claim 5 contains a motor/winch, cable, pulley, power cord with switch, wherein:

7. There is included one or more of the other patentable features in the specification hereof.

8. The portable crane/winch/hoist device of a second embodiment contains a tubular horizontal male member on one end being connected to a transitional member that accommodates two 360° vertical rise sections, each with a 45° horizontal rise connected to each other to form a long sweeping radius and the second terminal member being the boom section comprising:

9. The 2^{nd} embodiment of claim 8 contains a first 360° rotatable member that inserts into the round pipe vertical rise portion of the transition section and rests on a roller pin:

10. The assembly of claim 8 has a second round boom member that inserts into the female distal end of the first section of claim 9.

11. The assembly of claim 8 has a second round boom member that inserts into the female distal end of the first 360° rotatable member:

12. The portable crane/winch/hoist of claim 8 has a motor/winch, cable, pulley, lifting hook and power cord with switch:

13. The assembly of claim 8 contains an adjustable foot/base load bearing support with lock nut on the bottom of the 90° angular tubular to round vertical rise pipe transitional member.

14. A method of assembly of claim 1, 1^{st} preferred embodiment comprising the following steps:
connecting the trailer hitch adapter male end to the female receptacle of the trailer hitch, pin, then insert the male end of the transition into the female end of the adapter member pin, adjust the foot/base support to the terrain, lock in place with lock nut, then insert male end of rotatable boom section to desired height either resting on the roller pin or on the bottom of the pipe section.

15. A method of operation of claim 14, after assembling components, attach lifting hook to object load after releasing adequate length of cable with power cord switch, commence lifting vertically, rotating horizontally to desired location, energize switch to lower and deposit load, remove lifting hook then energize switch to reel in cable, disassemble portable crane/hoist then proceed to location to unload load, using the reverse operation of the power switch, then repeat the disassembly procedure.

16. A method of assembly of claim 8, second embodiment:
connect the trailer hitch adapter member to the trailer hitch, pin, insert the transition into the tubular end of the adapter, pin, adjust the foot/base and lock in place, followed by insertion of the first vertical rise male end into the female round pipe vertical rise member, then insert the male end of the second vertical rise boom member into the female end of the first of these two rotatable sections.

17. A winching assembly of the 1^{st} embodiment of claim 1, comprises a horizontal perpendicular adapter/transition 90° member that inserts into the female trailer hitch assembly, pinned and the 90° vertical rise female round pipe end receives the male vertical rise round pipe boom section, is pinned for non-rotating stability, to direct the load in a longitudal path to the center of the vehicle.

18. A method of claim 17, using power cord switch to release winch cable with lifting hook to a remote allowable location, then winched horizontally to a closer location for lifting, loading and unloading.

19. The winching device of claim 17 wherein:
there is included one or more of the other patentable features disclosed in the specification hereof.

20. The method of claim 18, using one or more steps disclosed in the foregoing specification with respect to the methodology of the invention.
